(19) United States
(12) Patent Application Publication
(10) Pub. No.: US 2015/0127648 A1
(43) Pub. Date: May 7, 2015

(54) IMAGE DESCRIPTOR FOR MEDIA CONTENT

(71) Applicants: Patrick Perez, Rennes (FR); Joaquin Salvatierra Zepeda, St. Jacques-de-la-Lande (FR)

(72) Inventors: Patrick Perez, Rennes (FR); Joaquin Salvatierra Zepeda, St. Jacques-de-la-Lande (FR)

(73) Assignee: THOMSON LICENSING, Issy de Moulineaux (FR)

(21) Appl. No.: 14/406,204

(22) PCT Filed: Jun. 7, 2012
(86) PCT No.: PCT/EP2012/060779

§ 371 Date: Dec. 5, 2014

(51) Int. Cl. G06F 17/30

(52) U.S. Cl. CPC G06F 17/30247; G06F 17/3028; G06F 17/30271
USPC 707/737; 707/736; 707/742

(57) ABSTRACT

A method for generating image descriptors for media content of images represented by a set of key-points, fn, is recommended which determines for each key-point of the image, designated as a central key-point, a neighbourhood of other key-points, fml, whose features are expressed relative to those of the central key-point. A sparse photo-geometric descriptor, SPGD, of each key-point in the image being a representation of the geometry and intensity content of a feature and its neighbourhood is provided to perform an efficient image querying for efficient searches. The approach demonstrates that incorporating geometrical constraints in image registration applications does not need to be a computationally demanding operation carried out to refine a query response short-list.

The invention relates to a method for generating improved image descriptors for media content and a system to perform efficient image querying to enable low complexity searches.

### BACKGROUND OF THE INVENTION

Computer supported image search in general, for example when trying to find all images of the same place in an image collection, is a request for large data bases. Well known systems for image search are e.g. Google's image-based image search and tineye.com. Some systems are based on a retrieval of meta data as a descriptive text information for a picture as e.g. a movie poster, cover, label of a wine or descriptions of works of art and monuments, however, sparse representations as so-called image descriptors are a more important tool for low complexity searches for an object and scene retrieval of all the occurrences of a user outlined object in a video with a computer by means of an inverted file index. An example is “Video Google: A text retrieval approche to object matching in videos” as disclosed by J. Sivic and A. Zisserman in Proceedings of the Ninth IEEE International Conference on Computer Vision ICCV 2003. A vector quantization of local descriptors is used to achieve sparsity while discarding the geometric information conveyed in position and scale of key-points. This quantization procedure, while enabling low-complexity matching, significantly degrades the descriptive power of the local descriptor vectors. That means that the reduced complexity obtained by means of very sparse vectors comes at the expense of degraded vector descriptiveness. One standard method used to correct the weakened descriptiveness originated by vector quantization consists of using geometric post-verification applied to a short-list of query responses. The method requires a high expenditure and is restrictive as it requires an estimation of the homography between each potential matching pair of images and further assumes that this homography is constant over a large portion of the scene. A weak form that does not require estimating the homography and incurs only marginal added complexity is also known, however, this approach is complementary to a full geometric post-verification process.

### SUMMARY OF THE INVENTION

It is an aspect of the invention to provide an improved image description method that exploits both the photometrical information of key-points and the geometrical layout i.e. the relative position of the key-points and nevertheless performs efficient image querying for a precise and fast search.

Problems in view of said aspects are solved by features disclosed in independent claims. Dependent claims disclose preferred embodiments.

A method for generating image descriptors for media content of images represented by a set of key-points is recommended which determines for each key-point of the image, designated as a central key-point, a neighbourhood of other key-points whose features are expressed relative to those of the central key-point.

Each key-point is associated to a region centred on the key-point and to a descriptor describing pixels inside the region. A region detection system is applied to the image media content for generating key-points as the centre of a region with a predetermined geometry. That means that image descriptors are generated by generating key-point regions, generating descriptors for each key-point region, determining geometric neighbourhoods for each key-point region, a quantisation of the descriptors by using a first visual vocabulary, expressing a neighbour of a neighbourhood region relative to the key-point region and quantizing this relative region using a shape codebook and a quantization of descriptors of neighbours of the neighbourhood region by using a second visual vocabulary for generating a photo-geometric descriptor being a representation of the geometry and intensity content of a feature and its neighbourhood. The photo-geometric descriptor is a vector for each key-point defined in the quantized photo-geometric space. The inverted file index of the sparse photo-geometric descriptors is stored in a program storage device readable by machine to enable low complexity searches.

It is a further aspect of the invention to provide a system for providing descriptors for media content of images represented by a set of key-points, which comprises a program storage device readable by machine, tangibly embodying a program of instructions executable by the machine to perform method steps for generating descriptors for image media content. Said method comprises the steps of applying a key-point and region generation to the image media content to provide a number of key-points each with a vector specifying the geometry of the corresponding region,

generating a descriptor for the pixels inside the region,

a quantisation of the descriptors by using a first visual vocabulary,

determining, for each key-point neighboring key-points with similar regions,

normalisation and quantisation of the neighbouring regions relative to the region and a quantisation using a shape codebook and

a quantization of neighbourhood descriptors in each of the neighbourhood regions by using a second visual vocabulary for providing a sparse photo-geometric descriptor—abbreviated as SPGD—of each key-point in the image being a representation of the geometry and intensity content of a feature and its neighbourhood. The sparsity of the descriptor means that an inverted file index of the photo-geometric descriptor is stored in a program storage device readable by machine to enable fast and low complex searches.

The geometric neighbourhood of the geometric neighbourhood region to a region is determined by applying thresholds to vectors within a four-dimensional parallelogram centered at the position of the region.

The method is unlike known approaches which, for large scale search, first completely discard the geometrical information and subsequently take advantage of it in a costly short-list post-verification based on exhaustive point matching.

According to the invention, a local key-point descriptor is recommended that incorporates, for each key-point, both the geometry of surrounding key-points as well as it's photometric information by the local descriptor. That means that for each key-point, a neighbourhood of other key-points whose relative geometry and descriptors are encoded in a sparse vector using visual vocabularies and a geometrical codebook. The sparsity of the descriptor means that it can be stored in an inverted file structure to enable low complexity searches. The proposed descriptor, despite its sparsity, achieves performance comparable or better to that of a scale-invariant feature transform abbreviated as SIFT.

A local key-point descriptor that incorporates, for each key-point, both the geometry of the surrounding key-points as well as their photometric information through local descriptors is determined by a quantized photo-geometric subset as the Cartesian product of a first visual codebook for the central key-point descriptor, a geometrical codebook to quantize the relative positions of neighbors and a visual codebook for the descriptors of the neighbors.

That means that a Sparse Photo-Geometric Descriptor, in the following abbreviated SPGD, is provided that is a binary-valued sparse vector of a dimension equal to the cardinality of this subset and having non-zero values only at those positions corresponding to the geometric and photometric information of the neighboring key-points.

The proposed SPGD ensures that it is possible to obtain a sparse representation of local descriptors without sacrificing descriptive power. In fact, the proposed SPGD can outperform non-sparse SIFT descriptors built for several image pairs in an image registration application and geometrical constraints for image registration can be used to reduce the local descriptor search complexity. This is contrary to known approaches wherein geometrical constraints are applied as an unavoidable and high expenditure requiring short-list post-verification process.

The use of relative key-point geometry is similar to a known shape context description scheme as e.g. disclosed by Mori G., Belongie S., Malik J., “Efficient Shape Matching Using Shape Contexts”, IEEE Transactions on Pattern Analysis and Machine Intelligence, vol. 27, no. 11, pp. 1832-1837, November, 2005, with the difference that the SPGD recommended according to the present invention is based on key-points instead of contours and considers not only a pixel position but also key-point orientation and scale. Furthermore, SPGDs are very sparse vectors, which is not the case for shape context vectors. The quantized photo-geometric space relies e.g. on a product quantizer, wherein sub-quantizers are applied to the relative geometries and descriptors, rather than to sub-components of the descriptor vector. In this sense, the recommended SPGD is tailored specifically to image search based on local descriptors and although the SPGD exploits both the photometrical information of key-points as well as their geometrical layout, a performance is achieved comparable or even better to that of the SIFT descriptor.

A Sparse Photo-Geometric Descriptor—SPGD—is recommended that jointly represents the geometrical layout and photometric information through classic descriptors of a given local key-point and its neighboring key-points. The approach demonstrates that incorporating geometrical constraints in image registration applications does not need to be a computationally demanding operation carried out to refine a query response short-list as it is the case in existing approaches. Rather, geometrical layout information can itself be used to reduce the complexity of the key-point matching process. It is also established that the complexity reduction related to a sparse representation of local descriptors need not be enjoyed at the expense of performance. Instead it can even result in improved performance relative to non-sparse descriptor representations.

### BRIEF DESCRIPTION OF THE DRAWINGS

Exemplary embodiments of the invention are described with reference to the accompanying drawings, which show in:

FIG. 1 a flow chart illustrating steps for SPGD generation;

FIG. 2 diagrams for selecting SPGD—parameters;

FIG. 3 diagrams of recall—precision curves when using SPGD—parameters of FIG. 1 for all images of scenes of the Leuven-INRIA dataset;

FIG. 4 diagrams of the area curves when using SPGD—parameters of FIG. 1 for all images of scenes of the Leuven-INRIA dataset;

FIG. 5 illustrating an embodiment of features of SPGD generation with circles applied to an image.

### DETAILED DESCRIPTION OF AN EMBODIMENT OF THE INVENTION

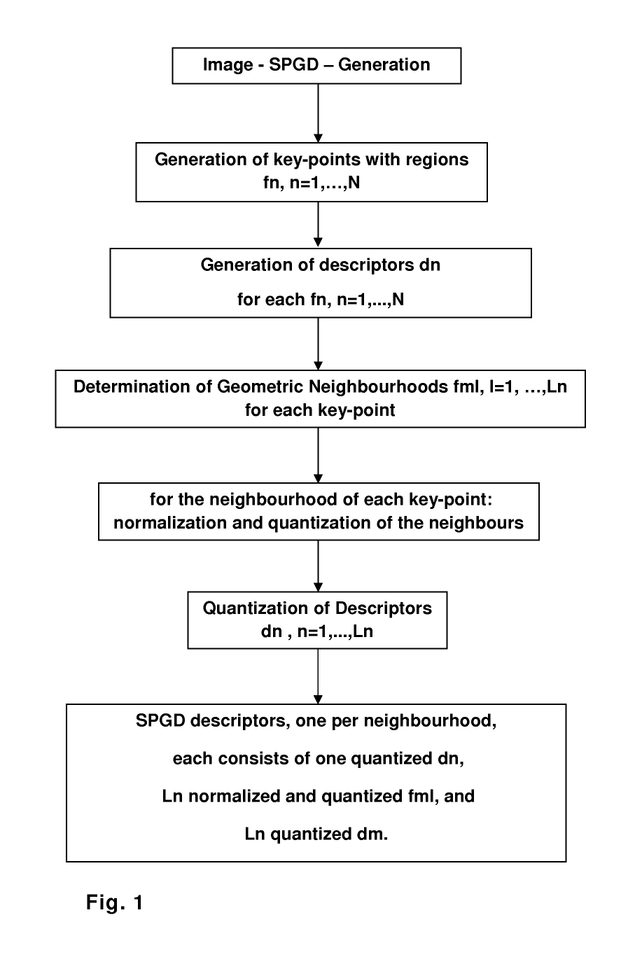

FIG. 1 shows a flow chart illustrating steps for SPGD or a so-called Sparse Photo-Geometric Descriptor generation for media content of images represented by a set of key-points. That means that it is assumed that an image is represented by a set of key-points with key-point regions fn, with each key-point having a vector specifying its geometry and a descriptor vector do summarizing the photometry of its surrounding, wherein n=1, . . . , N. Here is n an element of indices of image key-points nεI wherein n is the feature index, and I is the set of indices of image key-points. In a here disclosed embodiment, a Difference-of-Gaussian DoG detector is used to detect features having geometry vectors to determine key-points in regions fn, so that in a first step key point regions fn are generated as shown in FIG. 1 according to

fₙ=[log₂(σₙ),Δₓₙ,Δ_{yn},θₙ]^{T} (1)

which according to said formula 1 are consisting, respectively, of a scale or size σ, a central position xn and yn as coordinates of an area Δ as well as orientation parameters as an angle of orientation θn. For convenience it shall be assumed that the scale parameter size σ is expressed in terms of its logarithm.

The descriptor vectors do are built using the known SIFT algorithm.

The SPGD representation of a local key-point includes in such way geometric information of all key-points in a geometric neighborhood. To define a geometric neighborhood, a neighbourhood region fm is used and geometry is expressed in terms of reference geometry:

$${f}_{m} ∘ {f}_{n} = [ \begin{matrix}{log}_{2} ( {σ}_{m} ) - {log}_{2} ( {σ}_{n} ) \\ ( {Δ}_{xm} - {Δ}_{xn} ) / {σ}_{n} \\ ( {Δ}_{ym} - {Δ}_{yn} ) / {σ}_{n} \\ ( ( {θ}_{m} - {θ}_{n} - π ) mod 2 π ) - π\end{matrix} ] . \qquad ( 2 )$$

The geometrical neighborhood of a region fn is defined as all those vectors and neighbourhood descriptors dm respectively of a neighbourhood region fm that are within a 4-dimensional parallelogram centered at the key-point of region fn and with sides of half-lengths log₂ (T_{σ}), T_{Δ}, T_{Δ} and T_{θ}.

Letting T=diag(log₂(T_{σ}), T_{Δ}, T_{Δ}, T_{θ}), the indices of those shapes in the neighborhood of region fn can be expressed as follows:

MⁿΔ={mεI:m≠n̂∀k,|(T⁻¹(fₘ·fₙ))[k]|≦1} (3)

wherein v[k] denotes the k-th entry of a vector v and Mⁿ represents a neighbourhood.

For convenience it is assumed that the entries of neighbourhood Mⁿ are ordered as e.g. in increasing order, with the l-th entry denoted mₗⁿ. When possible, we will drop the superscript n and simply use mₗ for notational convenience.

The Sparse Photo-Geometric Descriptor consists of representing each key-point (fₙ,dₙ) along with the features (fₘ_{ₗ},dₘ_{ₗ}), mₗεMⁿ in its neighborhood using a mixed quantization approach. Let the quantization function based on codebook C={cₗ}ₗ produce the index l of the nearest codeword cₗ:

Q(v;C)=argminₗ|cₗ−v|. (4)

and Ln the number of neighbours of a key-point.

The SPGD construction process consists of three consecutive quantization steps. In the first step, the key-point descriptor do is quantized using a visual vocabulary v₁ as it is done in a large number of approaches:

vₙ=Q(dₙ;V₁). (5)

In the second step, vectors fₘ_{ₗ}, l=1, . . . , Lₙ of neighboring key-points are normalized relative to region fn and quantized using a shape codebook g:

sₗⁿ=Q(fₘ_{ₗ}·fₙ;g),l=1, . . . ,Lₙ. (6)

In the third step, the neighborhood descriptors dm are quantized using a visual vocabulary V₂.

cₗⁿ=Q(dₘ_{ₗ};V₂),l=1, . . . ,Lₙ (7)

The resulting SPGD (vₙ,{(sₗⁿ,cₗⁿ)}ₗ₌₁^{L}^{ₙ}) is a compact representation of the geometry and intensity content of a feature and its neighborhood.

That means as shown in FIG. 1 that geometric neighbourhoods fml, l=1, . . . , Ln are generated for each key-point and for the neighbourhood of each key-point a normalization and quantization of the neighbours is performed and finally a quantization of descriptors dn, n=1, . . . , Ln is performed to provide SPGD descriptors, one per neighbourhood, each consisting of one quantized descriptor dn, to the number Ln of neighbours of a key-point normalized and quantized geometric neighbourhoods fml of a key-point, and with the number Ln of neighbours of a key-point quantized descriptors dm of a neighbour key-point.

For comparing SPGDs:

The distance we propose to compare two SPGDs (Vₙ,{(sₗⁿ,cₗⁿ)}ₗ₌₁^{L}^{ₙ}) and (vₘ,{(sₖ^{m}, cₖ^{m})}ₖ₌₁^{L}^{ₘ}) establishes, in a low-complexity manner, to what extent the two underlying features region fn, descriptor dn and neighbourhood region fm, neighbourhood descriptor dm have neighboring features both of the same relative shape and with the same visual content. Whether the l-th feature in the neighborhood of feature n matches some feature in the neighborhood of feature m can be expressed as intersection or matching function γ as follows:

$$γ ( m ; n , l ) = \{ \begin{matrix}1 & if ∃ k s . t . {s}_{l}^{n} = {s}_{k}^{m} {c}_{l}^{n} = {c}_{k}^{m} \\ 0 & otherwise\end{matrix} \qquad ( 8 )$$

Using the above matching function, the following similarity Φ measure between two SPGDs is recommended, where δₖₗ is the so-called Kronecker delta function:

$$Φ ( n , m ) = {δ}_{{v}_{n} {v}_{m}} \cdot {\sum }_{l = 1}^{{L}_{n}} γ ( m ; n , l ) . \qquad ( 9 )$$

That means that SPGD descriptors are represented as sparse vectors defined in a high-dimensionality space. Accordingly, the distance of similarity Φ can be expressed as an inner product between these sparse vectors. To illustrate this, we define at first a sparse photo-geometric subset as being the Cartesian product A=V₁×g×V₂ of the three SPGD codebooks. We consider next the vector XₙεR^{|A|}, initialized to zero and having one entry per member triplet of A. An SPGD (vₙ,{(sₗⁿ,cₗⁿ)}ₗ₌₁^{L}^{ₙ}) can be represented as xₙ by setting to one all the positions of xₙ corresponding to the triplets (vₙ,sₗⁿ,cₗⁿ)∀l. The distance of similarity al function in equation (9) thus is obtained from the inner product xₙ^{T}xₘ, which shows that the SPGD similarity measure is symmetric.

The similarity measure in equation (9) e.g. can be computed efficiently by storing the database SPGDs using a four-level nested list structure. An SPGD (vₘ,{(sₖ^{m},cₖ^{m})}ₖ₌₁^{L}^{ₘ}) is appended to this structure as follows: The feature's descriptor quantization index vₘ serves as a key into the first list level. Each quantization index sₖ^{m} of the neighborhood shape structure is then a key into the second list index, and the corresponding quantized descriptor index cₖ^{m} is a key into the third list level, producing the fourth-level list L(vₘ,sₖ^{m},cₖ^{m}) where the feature index m is appended. When computing equation (8) for a query (vₙ,{(sₗⁿ,cₗⁿ)}ₗ₌₁^{L}^{ₙ}) and a large database of SPGDs (vₘ,{(sₖ^{m},cₖ^{m})}ₖ₌₁^{L}^{ₘ}), the fourth-level lists provide a pre-computation of γ(m;n,l):

$$γ ( m ; n , l ) = \{ \begin{matrix}1 & if m ∈ ℒ ( {v}_{n} , {s}_{l}^{n} , {c}_{l}^{n} ) , \\ 0 & otherwise\end{matrix} \qquad ( 10 )$$

Hence the similarity measure in equation (9) can be computed efficiently by aggregating over all those lists related to the neighborhood of the query SPGD:

$$Φ ( n , m ) = \vert \{ k ∈ {{⋃}^{{L}_{n}}}_{l = 1} ℒ ( {v}_{n} , {s}_{l}^{n} , {c}_{l}^{n} ) : k = m \} \vert . \qquad ( 11 )$$

That means that the query SPGD allows a low complex and efficient search.

A preliminary evaluation of the proposed SPGD descriptor is carried out by using image registration experiments disclosed by K. Mikolajczyk and C. Schmid. “A performance evaluation of local descriptors” IEEE Trans. Pattern Anal. Mach. Intell., 27(10):1615-1630, 2005.

Accordingly, Key-Points and their descriptors are first computed on a pair of images corresponding to different views of the same scene. Each key-point of the reference image is then matched to the key-point in the transformed image yielding the smallest descriptor distance or inverse similarity measure, and the match correctness is established using the nomography matrix for the image pair, allowing for a small registration error as e.g. 5 pixels. We then measure recall R and precision P, where

R=(# correct matches)/(# ground truth), (12)

P=(# correct matches)/(# total matches). (13)

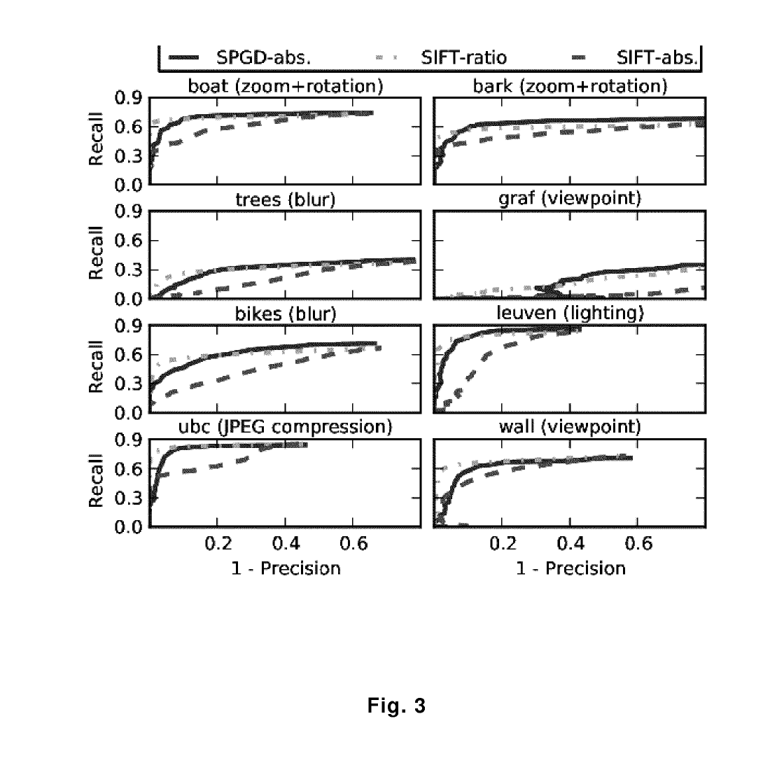

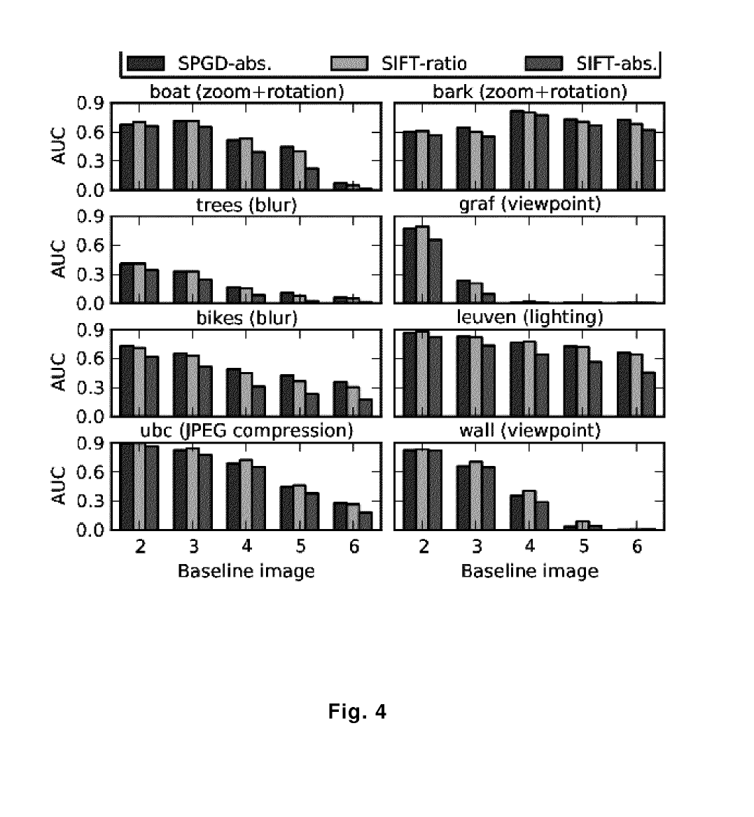

The total correct and wrong number of matches considered can be pruned by applying a maximum threshold on the absolute descriptor distance of matches. A second pruning strategy instead applies a maximum threshold to the ratio of distances to first and second nearest neighbours. We vary the threshold used to draw R, 1−P curves, using the labels abs. and ratio as shown in FIGS. 3 and 4 to differentiate between the two pruning strategies. We also use the Area Under the R, 1−P curve AUC to summarize performance in a single scalar value.

Note that the ratio-based pruning approach requires that the exact first and second Nearest Neighbors NN be found. In large scale applications where, as a result of the curse of dimensionality, approximate search methods are mandatory, this ratio-based match verification approach is not possible. Pruning based on the absolute distance order is more representative of approximate schemes where the exact first and second Nearest Neighbors NN is very likely to be found in the short-list returned by the system. Indeed for the proposed SPGD descriptor we only consider the exact first and second Nearest Neighbors NN matching, whereas for the reference SIFT descriptor we will consider both matching strategies, as using an absolute threshold greatly improves SIFT's R, 1−P curve. The image pairs used to measure recall R and precision P are those of the Leuven-INRIA dataset as disclosed by above mentioned K. Mikolajczyk and C. Schmid. “A performance evaluation of local descriptors”. The image pairs consist of eight scenes as boat, bark, trees, graf, bikes, leuven, ubc and wall with six images per scene labeled 1 to 6. Image 1 from each scene is taken as a reference image, and images 2 through 6 are transformed versions of increasing baseline. The transformation per scene is indicated in FIG. 3 and FIG. 4. The nomography matrices relating the transformed images to the reference image are provided for all scenes.

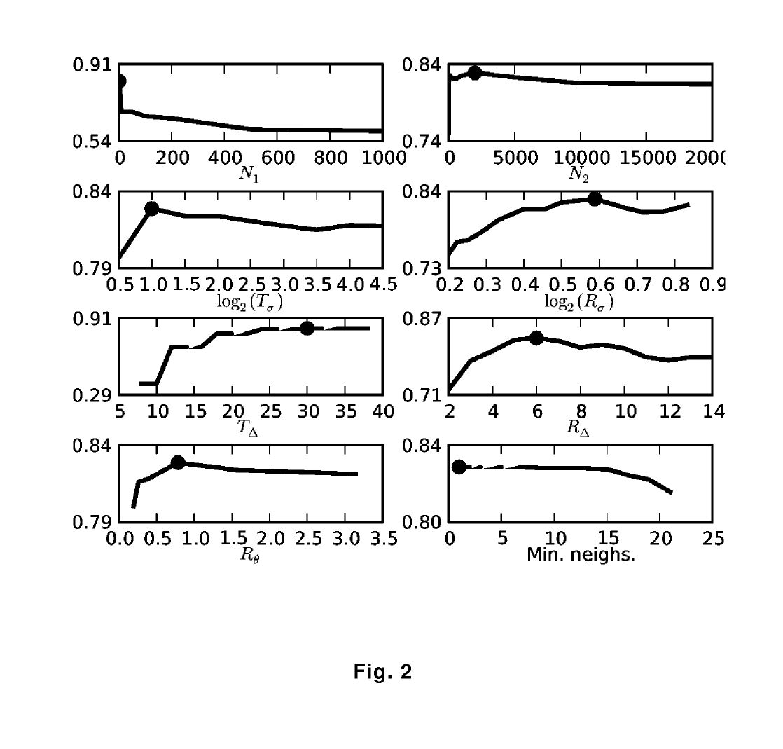

The publicly available Flickr-60K visual vocabularies are used according to H. Jégou, M. Douze, and C. Schmid. “Hamming embedding and weak geometric consistency for large scale image search”, ECCV, volume I, pages 304-317, 2008. These visual vocabularies have sizes between 100 and 200000 codewords and are trained on SIFT descriptors extracted from 60000 images downloaded from the Flickr website. We also build smaller vocabularies of size 10 and 50 by applying a K-means on the size of 20,000 vocabulary. For consistency of presentation, we also consider a trivial, size 1 vocabulary as shown in FIG. 2 to refer to situations where central descriptors do not contribute to SPGD descriptiveness.

FIG. 2 shows diagrams for selecting SPGD—parameters by comparing a plot of the area under (R,1−P)-curve versus SPGD parameters. When varying one parameter, all remaining parameters are fixed to the optimum value. This optimal parameters are indicated by a dark circle on the curves are:

N₁=1; N₂=2,000; log₂(T_{σ})=1; log₂(R_{σ})=0.59; T_{Δ}=30; R_{Δ}=6; R_{θ}=0.79; Min. neighs.=1.

The following parameters need to be specified to define an SPGD description system:
the geometrical quantizer requires the maximum relative scale,
translation and angle respectively, log₂(T_{σ}), T_{Δ}, T_{θ}) defining a geometrical neighborhood, as well as
the corresponding quantizer resolutions log₂(R_{σ}), R_{Δ} and R_{θ}.

While the values log₂(T_{σ}) and T_{Δ} determine SPGD invariance to image scale and cropping, T_{θ} only serves to control the effective size of the geometrical neighborhoods and hence the matching complexity.

In this embodiment it is assumed T_{θ}===π, meaning that relative angle is not used to constrain the geometrical neighborhoods and hence only 5 parameters are required to define the geometrical quantizer.

The sizes N1 and N2 of the visual codebooks V₁ and V₂ have to be determined. Furthermore, a minimum neighborhood size is selected, discarding local descriptors that have too few geometrical neighbors, resulting in a total of 8 parameters to be selected.

To select these 8 parameters we maximize the Area Under the R,1−P-Curve AUC for image 3 relative to image 1 of the leaven dataset.

We use an iterative, coordinate-wise, exhaustive search over a coordinate-dependent set of discrete values to find a local maximum of the AUC curve. The AUC values versus the discrete parameter sets for the last iteration of the maximization are displayed in FIG. 2.

The parameter selection approach as described above maximizes only performance. A better approach would maximize performance subject to a constraint on query complexity as measured, for example, by the cumulative length of lists from the inverted file visited during the query process. This measure of complexity will decrease with increasing resolution of the various quantizers. One would expect low complexity and high performance to imply opposing parameter requirements. Yet in only one case for sizes N1 of the visual codebooks V₁ does large quantizer bin size of highest complexity results in maximum performance. This suggests that other methods should be tried to use the information of the central key-point descriptor when designing an SPGD. A simple approach consists of a multiple assignment strategy where the query central descriptor is assigned to K>1 visual words from the first visual vocabulary v1

Another approach consists of discarding quantization over the first visual vocabulary v1 altogether and instead subtracting the central key-point descriptor from those of neighboring key-points, accordingly training the second visual vocabulary v2 on a set of such re-centered neighbouring key-point descriptors dm.

The performance of the SPGD is illustrated in FIGS. 3 and 4 as FIG. 3 shows R, 1−P curves when using the parameters specified by the circle-markers in FIG. 2 for image 3 versus image 1 of all scenes of the Leuven-INRIA dataset. We consider both an absolute match-pruning threshold as well as a pruning threshold applied on the first-to-second Nearest Neighbor NN distance ratio for the SIFT descriptor. It has to be noticed that, when both schemes use the absolute threshold pruning strategy, the SPGD descriptor outperforms the SIFT descriptor for all or nearly all the range of precisions on all scenes. The comparison against SIFT with ratio threshold is less favorable yet, for six out of the eight scenes, SPGD outperforms SIFT starting at 1-P values between 0.15 and 0.38.

FIG. 4 shows the Area Under the R, 1−P curve AUC for all baseline images of all scenes of the Leuven-INRIA dataset. The two scenes where SPGD matches or outperforms SIFT with both absolute- and ratio-based pruning for all baselines are the images bark and bikes. These are two scenes where the transformation, zoom+rotation and blur respectively, considered is well accounted for by the geometrical framework of the SPGD descriptor. They are also scenes containing a large extent of repetitive patterns: the bark scene is a close-up of the bark of a tree, while most of the area of the bikes scene consists of repetitive window or wall patterns. While local descriptors will be very similar for key-points at different positions of the same pattern, the SPGD descriptor can distinguish between these key-points using the geometry of the surrounding key-points. Hence SPGD offers an advantage when the images in question involve repetitive patterns.

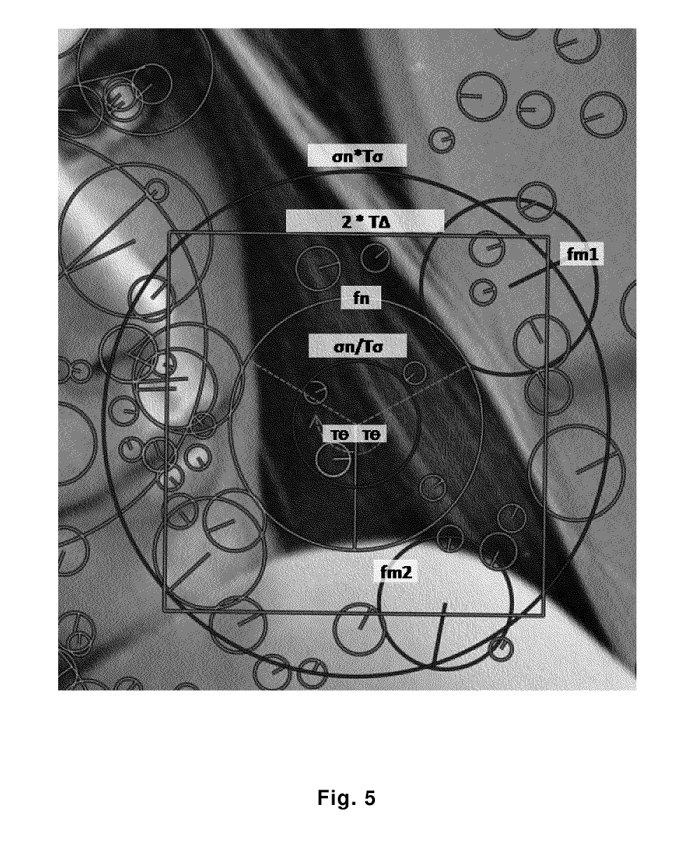

FIG. 5 illustrates an embodiment of features of SPGD generation with circles applied to an image. According to said embodiment the region fn is a circle and circles fm1 and fm2 are geometric neighbourhoods of a key-point of said region fn. FIG. 5 illustrates as an example where the neighborhood of key-point number n=540 with region fn is illustrated. This neighborhood consists of keypoints m1=452 and m2=479, and this because they have regions fm1 and fm2 that satisfy the constraints defined in equation 1 and equation 2 imposed by thresholds Tσ, TΔ and Tθ. The way in which these constraints are applied is illustrated visually in said FIG. 5 as in general key-point number m is a neighbor of key-point number n if:

its scale is greater than σn/Tσ and smaller than σn*Tσ, its offset relative to key-point n is less than TΔ and its angle difference relative to key-point n is less than Tθ. Only key-points m1 and m2 satisfy these constraints.
The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. Although the invention has been shown and described with respect to specific embodiments thereof, it should be understood by those skilled in the art that the foregoing and various other changes, omissions and additions in the form and detail thereof may be made therein without departing from the spirit and scope of the claims.

1. A method for generating image descriptors for media content of images represented by a set of key-points, comprising determining for each key-point of the image, designated as a central key-point, a neighbourhood of other key-points whose features are expressed relative to those of the central key-point.

2. The method according to claim 1, wherein each key-point is associated to
a region centred on the key-point and to
a descriptor describing pixels inside the region.

3. The method according to claim 1, wherein for generating key-points and their region with a predetermined geometry, a region detection system is applied to the image media content.

4. The method according to claim 1, wherein image descriptors are generated by
generating key-point regions,
generating descriptors for each key-point region,
determining geometric neighbourhoods (fml, l=1, . . . , Ln) for each key-point region,
a quantisation of the descriptors by using a first visual vocabulary,
for expressing each neighbour of each neighbour key-point region relative to the key-point region and quantizing this relative region using a shape codebook (V) and
a quantization of descriptors of neighbours by using a second visual vocabulary for generating a photo-geometric descriptor being a representation of the geometry and intensity content of a feature and its neighbourhood.

5. The method according to claim 4, wherein the first visual vocabulary for the key-point is generated by clustering training descriptors from a set of training images.

6. The method according to claim 4, wherein the shape codebook corresponds to a product quantizer formed by uniform scalar quantizers applied each to each parameter defining the region.

7. The method according to claim 4, wherein the second visual vocabulary for neighbour descriptors is obtained by clustering training descriptors from a set of training images.

8. The method according to claim 4, wherein the photo-geometric descriptor is a vector for each key-point that has as many positions as there are possible combinations of codewords one each from the first visual vocabulary, the shape codebook as well as the second visual vocabulary and has non-zero values only at those positions corresponding to combinations of codewords that occur in the neighbourhood associated to that key-point.

9. The method according to claim 4, wherein an inverted file index of photo-geometric descriptors is stored in a program storage device readable by machine to enable searches.

10. A system for providing descriptors for media content of images represented by a set of key-points, comprising a program storage device readable by machine, tangibly embodying a program of instructions executable by the machine to perform method steps for generating descriptors for image media content, said method comprising the steps of:
applying a key-point and region generation to the image media content to provide a number (n=1, . . . , N) of key-points each with a vector specifying the geometry of the region,
generating a descriptor for the pixels inside the region,
a quantisation of the descriptors by using a first visual vocabulary,
determining, for each key-point neighboring key-points with regions,
normalisation and quantisation of the neighbouring regions relative to the region and a quantisation using a shape codebook and
a quantization of neighbourhood descriptors in each of the neighbourhood regions by using a second visual vocabulary for providing a photo-geometric descriptor of each key-point in the image being a representation of the geometry and intensity content of a feature and its neighbourhood.

11. The system according to claim 10, wherein a geometric neighbourhood of key-points with the region is determined by those key-points having a vector falling within a parallelogram centred on the vector of the region.

12. The system according to claim 10, wherein an inverted file index of the photo-geometric descriptor is stored in a program storage device readable by machine to enable searches.

13. The system according to claim 10, wherein the photo-geometric descriptors are stored in the machine by using a four-level nested list structure.

14. The system according to claim 10, wherein the regions are determined by circles of a diameter, a position and an associated angle of orientation; a neighbour key-point number is determined to be a neighbour of a key-point number with the region if the relative region
fm·fn=(log(sm/sn),(xm−xn)/sn,(ym−yn)/sn((qm−qn−p)mod 2p)−p)
has entries with an absolute value falling below a maximum absolute value given respectively for each entry by thresholds and the thresholds are chosen to best suit by a training with images of the image media content.

15. An improved image descriptor for media content of images represented by a set of key-points stored on a program storage device readable by machine for describing and handling the media content which can be comprising a plurality of content symbols, the improvement comprises:
a photo-geometric descriptor that exploits both
the photometrical information of the key-points by local descriptors, and their geometrical layout in form of a relative position of the key-points and a relative shape of the region surrounding each key-point to perform an efficient image querying.

16. The improved image descriptor according to claim 15, wherein the improved image descriptor is a photo-geometric descriptor (SPCD) stored in an inverted file structure on a program storage device readable by machine to enable searches.

17. The improved image descriptor according to claim 15, wherein the improved image descriptor is
a binary-valued vector of a dimension equal to a product of cardinalities (|n1| |n2| |V|) of
a first visual codebook representing first visual vocabulary for a central key-point descriptor,
a geometrical codebook being a shape codebook to quantize the relative representations of neighbour regions and
a visual codebook represented by a second visual vocabulary for descriptors of neighbour regions.

18. The improved image descriptor according to claim 17, wherein the binary-valued vector has non-zero values only at those positions corresponding to the geometric and photometric information of neighbouring key-points.
